(19) United States
(12) Patent Application Publication
(10) Pub. No.: US 2002/0053022 A1
(43) Pub. Date: May 2, 2002

(54) Security arrangement for exchange of encrypted information

(75) Inventors: David Henry Groves, Adjala (CA); Viorel Ivanescu, Mississauga (CA); John R. Spence, Newmarket (CA)

Correspondence Address: Dennison Associates, Suite 301, 133 Richmond Street West, Toronto, ON, M5H 2L7, CA

(73) Assignee: IVI CHECKMATE CORP.

(21) Appl. No.: 09/982,783

(22) Filed: Oct. 22, 2001

(30) Foreign Application Priority Data
Oct. 30, 2000 (CA) 2,324,772

(51) Int. Cl. H04L 9/00

(52) U.S. Cl. 713/155; 705/67

(57) ABSTRACT

A method of remote loading of confidential information between a secure pin entry device and a Authorzing Institute using public and private key encryption techniques. In addition, a digital certificate uniquely identifying the terminal is provided by the terminal when a communication with the Authorzing Institute is originated. The Authorzing Institute confirms the authenticity of the digital certificate. This confirmation can occur using the public key of the Certificate Authority and/or confirmation can be made by contacting the Certificate Authority. In this way, confidence to use the public and private keys of the device and the Authorizing Institute for encryption is achieved, and financial keys and/or software can be encrypted downloaded to the device.

### FIELD OF THE INVENTION

The present invention relates to the manufacture of customized devices for communication with a predetermined authorizing institute which confirms the identity of the device prior to downloading of sensitive information and/or software.

### BACKGROUND OF THE INVENTION

Secure pin entry devices are placed at a host of diverse locations and operate in a non secure environment which is readily accessible to the public and the public typically has ready access to the secure pin entry device. These secure pin entry devices require financial keys and/or software to effectively communicate with a predetermined financial institute.

Traditionally, the secure pin entry devices have been manufactured in a controlled environment and critical information is subsequently injected into the secure pin entry device in a secure environment prior to placement in the field. These secure pin entry devices typically do not have a large amount of memory and depending upon the particular device or devices which the secure pin entry device must coordinate with, the software of the secure pin entry device varies. This memory limitation implies the software is specific for the particular application. It is also not desirable to inject these financial keys and/or software into the secure pin entry device and store them for later use as this poses a further security risk. In addition, if there is a service problem with respect to the secure pin entry device, it has to be returned to an injection facility to correct and/or reload critical information.

It would be desirable to have secure pin entry devices or other terminals which are customized for communication with a particular authorizing institute or other body where the terminal can be programmed by downloading of software and/or financial keys in a secure manner once communication with the authorizing institute has occurred. It would also be desirable to be able to reprogram terminals without requiring returning to a secure injection location.

### SUMMARY OF THE INVENTION

A secure pin entry device according to the present invention comprises a microprocessor, memory for storing of software and identification information of the device, a communication capability, encryption software, an activation program for initiating and completing a digital communication with an authorizing institute using the communication capability where the secure pin entry device includes a public encryption key stored in the memory, a private encryption key stored in secure memory, and a digital certificate which includes therein the public key and the identification information of the secure pin entry device.

In a preferred embodiment of the invention, the secure pin entry device includes an activation program having an address for initiating a communication with the authorizing institute.

In a further aspect of the invention, the secure pin entry device is customized for communication with an authorizing institute but requires the loading of financial keys and software from the authorizing institute which is completed using the encryption software and public key of the authorizing institute maintained in the secure pin entry device.

In yet a further aspect of the invention, the secure pin entry device includes a connection port for communicating with an electronic cash register system which forms part of the communication capability.

A method of downloading financial keys and software from an authorizing institute to a secure pin entry device comprises providing the secure pin entry device with a private key, a public key and a digital certificate wherein the digital certificate includes the public key of the secure pin entry device. A communication between the secure pin entry device and the authorizing institute is formed using the information previously provided to the secure pin entry device. The secure pin entry device transmits to the authorizing institute the digital certificate. The authorizing institute confirms the certificate. The secure pin entry device has or receives the public key of the authorizing institute and the authorizing institute and secure pin entry device using said keys, form a shared secret and the shared secret is used to encrypt and download financial keys and software to the secure pin entry device to program the secure pin entry device for operation and secure communication with the authorizing institute.

In a preferred aspect of the invention, the step of providing the secure pin entry device with the private key and the digital certificate occurs in a secure environment.

In a further aspect of the invention, the secure pin entry device is provided with its private key and public key by an Initialization System and the Certificate Authority communicates with the Initializing System through a secure communication.

In yet a further aspect of the invention, the method includes locating the Initializing System and the Certificate Authority in a common secure location.

A method of customizing a financial transaction device having a unique identification for communication with a financial institute having a private key and a public key, includes the steps of providing the unique identification to an Initializing System, having the Initializing System provide the financial transaction device with a private key and a public key, forwarding to a Certificate Authority the financial transaction device public key, and unique identification of the financial transaction device, producing at the Certificate Authority a certificate for the financial transaction device, providing the certificate to the financial transaction device and storing the certificate in the financial transaction device.

### BRIEF DESCRIPTION OF THE DRAWINGS

Preferred embodiments of the invention are shown in the drawings, wherein:

FIG. 1 is a schematic illustrating the initial customizing of secure pin entry devices;

FIG. 2 is a depiction showing various information which is maintained by the secure pin entry device; and

FIG. 3 shows communication between a secure pin entry device and a financial institute which will lead to downloading of software and financial keys.

### DETAILED DESCRIPTION OF THE PREFERRED EMBODIMENTS

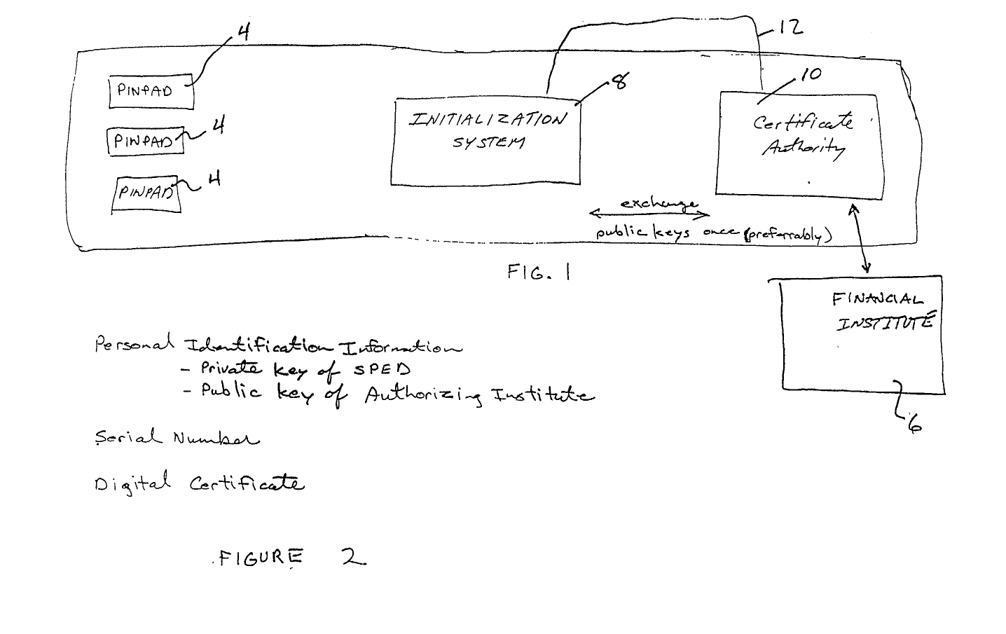

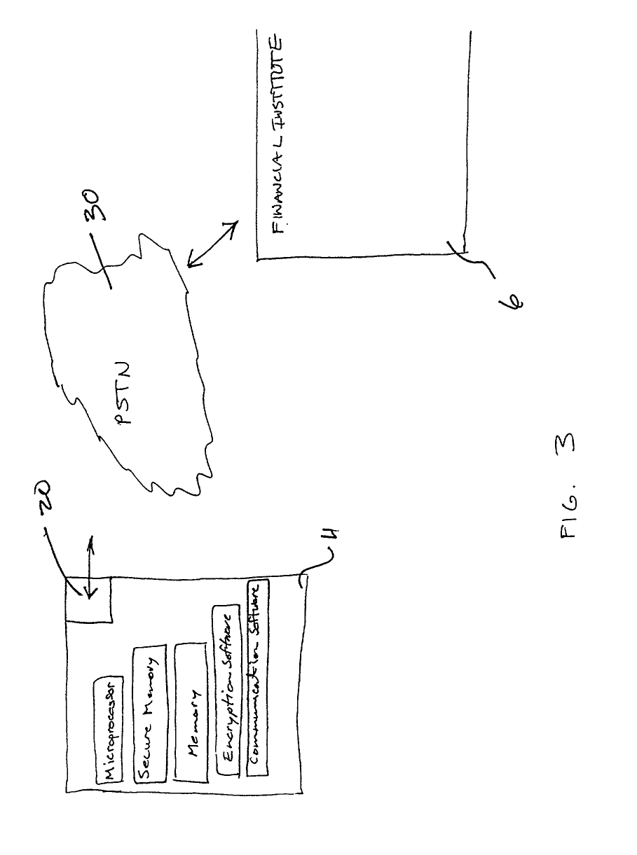

FIG. 1 shows a system 2 for customizing of secure pin entry devices 4 for eventual communication in an encrypted manner with the authorizing institute indicated as 6. This authorizing institute normally is a financial institute however it can be any institute which the secure pin entry devices 4 are to cooperate with. The secure pin entry devices and the Initialization System 8, as well as the Certificate Authority 10 are all preferably located in a secure environment. It is possible for the Initialization System to be a substantial distance from the Certificate Authority but improved security is provided if these are provided in close proximity to one another and preferably in the same premise. The various elements of the combination communicate with each other using the public key private key encryption techniques.

The Initialization System 8 receives from the secure pin entry device 4 its serial number, and prepares a Personalization Table for the device based on the public key of the Authorizing Institute which the secure pin entry device will eventually communicate with. This Personalization Table contains the private and public keys of the device and the public key of the Authorizing Institute. The Personalization Table increases the speed of future encryption operations. Personal identification information of the secure pin entry device, namely; the serial number, public key, and other identification information is provided to the Certificate Authority over a secure link 12. Preferably, the Initialization System and the Certificate Authority have previously exchanged public keys and this exchange was carried out in a secure environment. In this way, any further communication therebetween is secure. The Initialization System communicates this personal information using the public key of the Certificate Authority.

The Certificate Authority 10 receives the personal identification information and prepares a digital certificate using the private key of the Certificate Authority. This digital certificate is the personal identification information signed by the Certificate Authority. The digital certificate is returned to the Initialization System and stored in the secure pin entry device 4. Each secure pin entry device 4 will go through the same process and receive its own digital certificate. The Certificate Authority 10 and the particular authorizing institute 6 also communicate using the public keys. The Certificate Authority can provide the authorizing institute with the details of the certificate it has provided to secure pin entry devices 4 for future reference or may make this information available to the authorizing institute.

The secure pin entry device 4 as shown in FIG. 3 includes a microprocessor, secure memory for receiving the private key, the digital certificate and the public key of the Authorizing Institute, memory for receiving software and storing of other information, encryption software and communication software. There is also a communication port 20 which allows communication with the communication network 30. This communication network could be the public switched telephone network, a wireless network, a computer network, the internet or other communication network. The secure pin entry device itself, or the secure pin entry device in combination with an electronic cash register or other related equipment is required to complete an initial activation cycle. This activation cycle causes the secure pin entry device 4 to communicate through port 20 and through a communication network with the authorizing institute indicated as 6.

The secure pin entry device 4 provides the digital certificate to the authorizing institute. The authorizing institute uses the public key of the Certificate Authority to verify the digital certificate. If desired the digital certificate can be compared with information previously provided by the Certificate Authority 10 and/or the Certificate Authority can be contacted to receive further confirmation. The authorizing institute can have confidence that the secure pin entry device is indeed the secure pin entry device that was originally customized for communication with the authorizing institute and has not undergone tampering. It is extremely difficult to alter information contained in a digital certificate without knowledge of the private key of the Certificate Authority.

The secure pin entry device 4 will then cooperate with the authorizing institute 6, such as a financial institute, and download financial keys and any processing software. These communications are encrypted and preferably, the secure pin entry device 4 and the financial institute form a shared secret for more efficient transmission of this critical financial information as well as software. Preferrably, each secure pin entry device is customized whereby it can only communicate with predetermined authorizing institutes.

In addition, for the situations where the SPED (secure pin entry device) requires increased protection to its sensitive information, a “two way authentication method” can be used.

By authenticating the incoming communication (i.e. loading of new software, keys, identification information) the SPED is able to ensure that only the specific Authorizing Institute attempts some sensitive operations. This improved security could be achieved by providing each sensitive command with a special field where the Authorizing Institute places an authentication string for the corresponding communication packet. Here are two examples for generating the authentication string: 1) The Authorizing Institute calculates the Message Authentication Code (MAC) of the command using the shared secret previously generated and a symmetric cryptographic algorithm like DES; and 2) The Authorizing Institute calculates the signature of the command string using its unique private key. Once the SPED receives the sensitive command, it will verify its authentication string and execute the command only if the verification is successful.

As outlined above, it is possible for the financial institute, if desired, to contact the Certificate Authority 10, and have the Certificate Authority confirm the certificate provided by the secure pin entry device or for the Certificate Authority to provide the information to the financial institute which allows it to additionally confirm the digital certificate. As can be appreciated, the digital certificate is signed by the Certificate Authority using its private key and the financial institute can in fact, confirm the digital certificate using the public key of the Certificate Authority and then compare that information with information that has been previously stored with the financial institute. If it is not desired for the Financial Institute to store this information, it is apparent that a live communication can be made between the financial institute and the Certificate Authority for confirmation.

If there is any attempt to change the information in the certificate, it will result in a change in the digital signature, or when the digital signature is recalculated, there will not be a match.

With this arrangement, the secure pin entry device is preferrably customized for secure communication with a particular financial institute or other authorizing institute prior to activation. At the time of activation, the financial institute and the secure pin entry device can form a secure communication and thereafter appropriately program the secure pin entry device in the most desirable manner. This can include updated software and/or a different application than was originally anticipated. Furthermore, it is possible to update secure pin entry devices in the field using this secure communication technique. In this way, the necessity to return the secure pin entry device to a secure environment is avoided, while confidence in the downloading of information and financial keys is maintained. This technique also has application for devices other than secure pin entry devices where the device is to communicate with a known body or one of a number of bodies, and information can be loaded regarding that communication for eventual activation.

The above is the preferred method but variations can be made thereto which maintain a high degree of security but not necessarily to the same extent as discussed. With this particular method and the receipt and storage of a digital certificate and public key of the authorizing institute, prior to placement in the field, a high degree of confidence is obtained. This security is further improved when the particular authorizing institute also receives the digital certificate or other information from the Certificate Authority whereby a further confirmation can be carried out.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A secure pin entry device comprising:
a microprocessor,
memory,
secure memory,
identification information,
a communication capability,
encryption software,
an activation program for completing a digital communication with an authorizing institute using said communication capability,
said secure pin entry device including:
a public encryption key stored in said memory,
a private encryption key stored in said secure memory and a digital certificate which includes therein the public key and said identification information of said secure pin entry device.

2. A secure pin entry device as claimed in claim 1 wherein said activation program includes a communication address to initiate a communication with the authorizing institute.

3. A secure pin entry device as claimed in claim 1 wherein said secure pin entry device is ready for loading of financial keys and software from the authorizing institute using said encryption software and said public and private keys.

4. A secure pin entry device as claimed in claim 1 includes:
a connection port for an electronic cash register system which forms part of said communication capability.

5. A secure pin entry device as claimed in claim 1 wherein said activation program incudes information specific to a predetermined authorizing institute which the device will communicate with.

6. A secure pin entry device as claimed in claim 1 wherein said device activation program is limited to a predetermined authorizing institute.

7. A method of downloading of confidential information or software from an authorizing institute to a secure pin entry device said method comprising:
providing said secure pin entry device with personal identification information including a serial number, a private key, a public key, and a digital certificate provided by a Certificate Authority having a public key and a private key and wherein said digital certificate includes the public key of said secure pin entry device,
locating said secure pin entry device in an operating location, forming a communication between said secure pin entry device and said authorizing institute and transmitting to said authorizing institute, said certificate;
said authorizing institute confirming said certificate using the public key of said Certificate Authority,
said secure pin entry device and said authorizing institute using said keys to encrypt and download confidential information received and deciphered by said secure pin entry device and used to program said secure pin entry device for secure communication with said authorizing institute.

8. A method as claimed in claim 7 Wherein said secure pin entry device and said authorizing institute use said keys to form a shared secret, and said shared secret is used to encrypt and decipher said confidential information used to program said secure pin entry device.

9. A method as claimed in claim 7 wherein the step of providing said secure pin entry device with said private key and said digital certificate occurs in a secure environment.

10. A method as claimed in claim 9 wherein said secure pin entry device is provided said private key and public key by an Initialization System and said Certificate Authority communicates with said Initialization System through a secure communication link.

11. A method as claimed in claim 10 including locating said Initialization System and said Certificate Authority in a common secure location.

12. A method as claimed in claim 10 wherein said Certificate Authority and said Initialization System exchange public keys initially, and thereafter communication using encryption based on said keys.

13. A method as claimed in claim 12 wherein the exchange of said public keys between said Certificate Authority and said Initialization System occurs only as required, and infrequently.

14. A method as claimed in claim 7 wherein said confidential information includes financial keys and/or software.

15. A method as claimed in claim 7 including providing said secure pin entry device with information specific to the authorizing institute prior to locating said device whereby the device is specific to the authorizing institute.

16. A method of customizing a financial transaction device having a unique identification for communication with a Financial Institute having a private key and a public key,
said method comprising providing said unique identification to an Initialization System;
having said Initialization System provide said financial transaction device with a private key and a public key, forwarding to a Certificate Authority the financial transaction device public key and unique identification; producing at the Certificate Authority a digital certificate for said financial transaction device;
providing said certificate to said financial transaction device; and
storing said certificate in said financial transaction device.

17. A method as claimed in claim 16 including having said Initialization System provide said transaction device with a communication address of said Financial Institute.

18. A method as claimed in claim 17 including having said Initialization System provide said financial transaction device with an initiation program used to initiate a communication with said Financial Institute using said communication address.
